(19) United States
(12) Patent Application Publication
(10) Pub. No.: US 2025/0346047 A1
(43) Pub. Date: Nov. 13, 2025

(54) DIGITAL PRINTING SYSTEM AND METHOD FOR PRINTING ON A RADIATION TRANSPARENT SUBSTRATE

(71) Applicant: XEIKON MANUFACTURING N.V., LIER (BE)

(72) Inventors: Jürgen Norbert Bart DEVLIEGHERE, BORGERHOUT (BE); Lode Erik Dries DEPREZ, LIER (BE); Nick HOREMANS, NOORDERWIJK (BE)

(73) Assignee: XEIKON MANUFACTURING N.V., LIER (BE)

(21) Appl. No.: 18/860,913

(22) PCT Filed: Apr. 28, 2023
(86) PCT No.: PCT/EP2023/061253

§ 371 Date: Oct. 28, 2024

(30) Foreign Application Priority Data
Apr. 29, 2022 (NL) 2031741

(51) Int. Cl. B41J 11/00; B41J 2/21

(52) U.S. Cl. CPC B41J 11/00214; B41J 2/2117

(57) ABSTRACT

A printing system for printing on a substrate having a first side and a second side. The system includes an image application device for applying a radiation curable printing composition, preferably a light curable printing composition, typically a light curable ink, onto the first side of the substrate, a first curing device for emitting radiation, preferably light radiation, onto the first side of the substrate to cure at least a portion of the radiation curable printing composition, where the first curing device is located downstream of the image application device, a second curing device for emitting radiation, preferably light radiation, through the second side of the substrate to cure at least a portion of the radiation curable printing composition applied on the first side, where the second curing device is located downstream of the image application device.

### FIELD OF INVENTION

The field of the invention relates to digital printing methods and systems for printing on packaging materials, in particular for printing on flexible packaging materials, such as thin sleeves or foils.

### BACKGROUND

Ink printing systems, such as ink-jet printers or offset printing presses, are known to incorporate curing lamps in order to cure known radiation curable inks, for example an ultra-violet (UV) curing device such as a UV lamp to cure a UV curable ink.

In such ink printing systems, a radiation curable ink is applied onto a substrate, e.g. paper, and then is cured by a curing device. Ideally, the curing devices cures substantially all of the ink by radiating the printing side of the substrate. The substrate is generally moved throughout the system, from the location of the printing device to the location of the curing device, by one or more rollers, belts, or the like.

When multiple layers of ink are applied on the substrate, when inks which reflect a portion of the UV light are used and/or when an ink, such as a black ink, absorbs a significant portion of the UV light, curing by radiating the printing side may not be sufficient to obtain a well cured printed layer. Such problems occur, for example, when reverse printing on transparent substrates where multiple colors may be combined with a white layer.

US 2009/0135239A1 discloses an ink printing device that incorporates a curing lamp located on the opposite side of a printed face of a printed substrate and partially cures a radiation curable ink by irradiating through the substrate.

US2020/0310289A1 discloses a digital printing process for xerography printing with curable dry toner. The process includes: forming a latent image as a pattern of electric charge on a surface of an imaging member; transferring dry toner onto a development member; developing the latent image by transferring dry toner from the development member onto the imaging member in accordance with the pattern; transferring the dry toner from the imaging member to a first substrate; applying a second substrate on the transferred dry toner, fusing the transferred dry toner, and bonding the second substrate to the first substrate.

US2019/0146377A1 discloses a digital printing process for xerography printing with liquid toner is disclosed, said liquid toner including a curable carrier liquid and imaging particles suspended in the carrier liquid.

CN113226778A discloses a liquid discharge device that can ensure the dot gain of ink droplets with a small amount of ink for recording media such as resin film or resin impregnated paper, and suppress the combination of adjacent ink droplets.

### SUMMARY

The object of embodiments of the invention is to provide an improved system and method for curing a radiation curable composition applied on a first side of a substrate, and in particular a system allowing a good curing, also in the event that the radiation curable composition is applied in multiple layers, in the event that the radiation curable composition partially reflects the radiation used for the curing and/or when an ink, such as a black ink, absorbs a significant portion of the UV light.

According to a first aspect there is provided a printing system for printing on a substrate having a first side and a second side. The printing system comprises an image application device, a first curing device and a second curing device. The image application device is configured for applying a radiation curable printing composition, preferably a light curable printing composition, typically a light curable ink, onto the first side of the substrate. The first curing device is configured for emitting radiation, preferably light radiation onto the first side of the substrate to cure at least a portion of the radiation curable printing composition. The first curing device is located downstream of the image application device. The second curing device is configured for emitting radiation, preferably light radiation, through the second side of the substrate to cure at least a portion of the radiation curable printing composition applied on the first side. The second curing device is located downstream of the image application device.

By performing a first curing with the first curing device on the first side and a second curing with the second curing device through the second side, the applied radiation curable printing composition is cured from two sides. This results in an enhanced curing, especially when the applied radiation curable printing composition contains multiple layers applied on top of each other. Indeed, a portion closest to the first side of the substrate can be cured by the second curing device and a portion furthest away from the first side can be cured by the first curing device. For example, when reverse printing on transparent substrates where a color layer may be combined with a highly reflective ink, such as white ink or silvery ink layer above and/or below the color layer, curing using the first and second curing device can improve the curing result in a significant manner.

It is noted that the first and second curing may be done consecutively or simultaneously. In some prior art solutions a first curing step is performed after application of a first layer of curable printing composition and before application of a second layer of curable printing composition, and a second curing step is performed after application of the second layer. Such a solution has the disadvantage that the substrate may shrink during the first curing step, and that, as a consequence, the second layer of curable printing composition is not well aligned with the first layer. By performing the first and second curing downstream of the image application step by the image application device, such misalignment problems are reduced or avoided.

Preferably, the image application device comprises a color application section and at least one additional layer application section. The color application section is configured for applying one or more colored curable printing compositions, such as any one or more of cyan, magenta, yellow, key (black) (CMYK) color inks. The at least one additional layer application section is configured for applying an additional curable printing composition, for example a highly reflective ink, such as white ink or silvery ink, or a strong absorbing ink, such as a black ink. In some embodiments an additional layer of additional curable printing composition may be applied below the colored curable printing compositions and/or an additional layer of additional curable printing composition may be applied on top of the colored curable printing compositions. In such embodiments where at least two layers are applied, curing from both sides using the first and the second curing device is advantageous for obtaining a thorough curing. Embodiments of the invention are especially advantageous when the at least one additional layer application section is configured for applying a highly reflective ink, such as white ink or silvery ink. Highly reflective ink, such as white ink or silvery ink typically reflects at least partially the light radiation which is used for curing. By curing from both sides, both the color layer as well as the highly reflective ink layer can be well cured. Also when a strong absorbing ink, such as a black ink, is applied, embodiments of the invention are useful. Strong absorbing ink such as black ink typically absorb at least a significant portion of the light radiation which is used for curing, leaving significantly less light radiation for the color layer, resulting in a low curing efficiency for said color layer. By curing from both sides, both the color layer as well as the strong absorbing ink layer, such as a black ink layer, can be well cured.

In other embodiments the image application device comprises only a color application section. The color application section is configured for applying one or more colored curable printing compositions, preferably multiple colored curable printing compositions, such as any one or more of cyan, magenta, yellow, key (black) (CMYK) color inks. In some embodiments, one of the colors applied by the color application section may be white. Also in such embodiments, curing from both sides may be beneficial.

Preferably, no curing or only a partial curing (pinning) is performed between the application of different curable ink compositions. This is different from prior art solutions where an applied layer is full cured before applying the next one. By applying no curing or only a partial curing (pinning) between the application steps of the different curable ink compositions, any shrinkage of the substrate between application steps can be avoided or limited. It is noted that a dose applied for pinning is typically at least ten times lower than a dose needed for a full curing of the applied curable printing composition.

In an exemplary embodiment, the color application section is located upstream and/or downstream of an additional layer application section of the at least one additional layer application section, such that the additional curable printing composition forms a top layer on a color layer applied by the color application section and/or a bottom layer between the first side of the substrate and the color layer, respectively.

Preferably, the second curing device is located downstream of the first curing device. This has the advantage that the curable printing composition on the first side of the substrate is at least partially cured from the top by the first curing device, so that the first side can be brought in contact with a transport member, such as a roller, during the curing by the second curing device whilst the risk of disturbing the image is limited or avoided.

Preferably, at least one of the first and second curing device is configured for cooling the applied curable ink composition during curing by the first and/or second curing device.

In a preferred embodiment, the first curing device comprises a heat transfer member, such as a roller, configured for supporting and being in contact with the second side of the substrate during curing by the first curing device; and/or the second curing device comprises a heat transfer member, such as a roller, configured for supporting and being in contact with the first side of the substrate during curing by the second curing device. This results in a compact structure, wherein curing and cooling can be performed simultaneously and wherein the heat transfer member also functions as a support member of the substrate. Additionally, such continuous contact of the substrate with a support member while curing avoids or limits deformation like shrinking or stretching of the substrate. In an exemplary embodiment where the first curing device comprises a first heat transfer member and the second curing device comprises a second heat transfer member, the first heat transfer member is located upstream of the second heat transfer member, and the first heat transfer member is arranged for being in contact with the second side of the substrate whilst the second heat transfer member is arranged for being in contact with the first already cured side of the substrate. When the first and second heat transfer members are first and second rollers, they may be arranged so that the substrate is guided along a first side of the first roller and next around an opposite second side of the second roller.

In another exemplary embodiment the first curing device is located downstream of the second curing device or opposite the second curing means.

In an exemplary embodiment, at least one of the first and second curing devices is configured for cooling the substrate with a gas flow during the curing by the first and/or second curing device and/or immediately after the curing by the first and/or second curing device.

In some embodiments it is preferred to apply the gas flow at the first side of the substrate in order to cool the applied curable printing composition, but in addition or alternatively it may also be advantageous to apply a gas flow at the second side, so that the substrate is also cooled and thus also a portion of the applied curable printing composition near the substrate. When for example a nitrogen gas flow is applied at the first side during curing by the first curing device, this has the additional advantage of causing oxygen inhibition which is typically advantageous for obtaining a good curing result.

Preferably, the first and second curing device are configured for emitting light radiation, more preferably UV light radiation. For example, the first and second curing device may comprise UV LEDs. However, it is also possible to use UV lamps or a combination of UV LEDs and UV lamps. Especially when the substrate is a transparent or translucent substrate, UV light has the advantage of being able to at least partially pass through the substrate. However, in some embodiments the radiation may be an electron beam (EB) for performing EB curing. The use of EB curing may be advantageous when the substrate is not transparent to UV light, or when the substrate allows only little UV light to pass through.

Preferably, the printing system comprises a drying station downstream of the image application device and upstream of the first and second curing device. For example, if the radiation curable composition is a water-based ink, it may be advantageous to perform drying, typically at least a partial drying, before the curing. Note that this partial drying is typically sufficient to cause film formation of the curable material within the curable ink composition, so that subsequently a film is cured by the first and second curing device.

Preferably, the image application device is an inkjet application device.

Preferably, the printing system further comprises a substrate transport means configured to transport the substrate as a continuous web during printing along the image application device and the first and second curing device.

According to a second aspect of the invention, there is provided a method for printing on a substrate having a first side and a second side. The method comprises:
applying a radiation curable printing composition, preferably a light curable printing composition, typically a light curable ink, onto the first side of the substrate;
emitting radiation, preferably light radiation onto the first side of the substrate, after the curable printing composition has been applied, to cure at least a portion of the radiation curable printing composition;
emitting radiation, preferably light radiation through the second side of the substrate, after the curable printing composition has been applied, to cure at least a portion of the radiation curable printing composition applied on the first side; wherein the substrate is configured to allow at least a portion of the radiation to pass through the substrate.

The technical merits of embodiments of the system apply mutatis mutandis for embodiments of the method.

Preferably, the applying comprises:
applying one or more colored curable printing compositions, such as one or more CMYK color inks, to form a color layer; and
applying an additional curable printing composition, for example a highly reflective ink, such as white ink or silvery ink, or a strong absorbing ink, such as a black ink, as a top layer on the color layer and/or as a bottom layer between the first side of the substrate and the color layer.

In another embodiment, the applying only comprises applying one or more colored curable printing compositions, preferably multiple colored curable printing compositions, such as one or more CMYK color inks and/or a white ink, to form a color layer.

Preferably, the emitting of radiation through the second side is performed after the emitting of radiation onto the first side. Alternatively, the emitting of radiation though the second side may be performed before or at the same time as the emitting of radiation onto the first side.

Preferably, the method further comprises cooling the substrate during the emitting of radiation onto the first side and/or onto the second side. The cooling may be done e.g. using a heat transfer member, such as a roller, and/or using a gas flow, such as an N₂ gas flow or a Helium gas flow. The gas flow may be applied onto the first side and/or onto the second side of the substrate, typically during curing.

According to a preferred embodiment, the substrate is first guided with its second side along a first heat transfer roller and the emitting of radiation on the first side is done while the substrate passes along the first heat transfer roller, and next guided with its first side along a second heat transfer roller and the emitting of radiation through the second side is done while the substrate passes along the second heat transfer roller.

Preferably, the radiation curable printing composition is a hybrid ink which can be cured and dried, such as a water-based ink. For example, the hybrid ink may be an emulsion of a curable liquid in water. By at least partially drying the applied curable ink composition before curing film formation of the curable liquid is caused, so that subsequently a film of the curable liquid is cured by the first and second curing device.

Preferably, the substrate is made of a polymer material, such as a polyethylene or polypropylene or a polyethylene terephthalate (PET) material. Preferably, the substrate is configured such that it does not absorb the radiation curable composition. In more preferred embodiments, the substrate is at least partially transparent to UV light, more preferably substantially transparent to UV light. For example, embodiments of the invention are useful for printing on substantially transparent substrates used e.g. for packaging applications, where the applied curable ink composition is visible through the substrate.

Preferably, the thickness of the substrate is between 5 and 100 micron, more preferably between 5 and 50 micron, even more preferably between 5 and 30 micron.

Preferably, the radiation is UV light radiation. However, for certain applications also electron beam radiation may be used.

Preferably, the applying is done by ink jetting.

Preferably, the substrate is transported as a continuous web during the applying and the emitting steps.

According to another aspect there is provided a substrate with a printed image obtained with the method of any one of the embodiments disclosed above, preferably using a printing system of any one of the embodiments disclosed above.

According to a further aspect, there is provided a method for packaging a product, comprising wrapping the substrate of the preceding aspect around the product, wherein preferably the packaging is done such that the printed first side of the substrate is facing the product. Yet another aspect relates to the packaged product obtained by this method.

### BRIEF DESCRIPTION OF THE FIGURES

The accompanying drawings are used to illustrate presently preferred non-limiting exemplary embodiments of the present invention. The above and other advantages of the features and objects of the invention will become more apparent and the invention will be better understood from the following detailed description when read in conjunction with the accompanying drawings, in which:

FIG. 1 illustrates schematically a digital printing apparatus and method according to an exemplary embodiment where the second curing device is arranged downstream of the first curing device;

FIG. 2 illustrates schematically a digital printing apparatus and method according to an exemplary embodiment where the second curing device is arranged opposite of the first curing device;

FIG. 3 illustrates schematically a digital printing apparatus and method according to an exemplary embodiment where the second curing device is arranged upstream of the first curing device; and

FIG. 4 illustrates schematically a digital printing apparatus and method according to a further developed exemplary embodiment.

### DESCRIPTION OF EMBODIMENTS

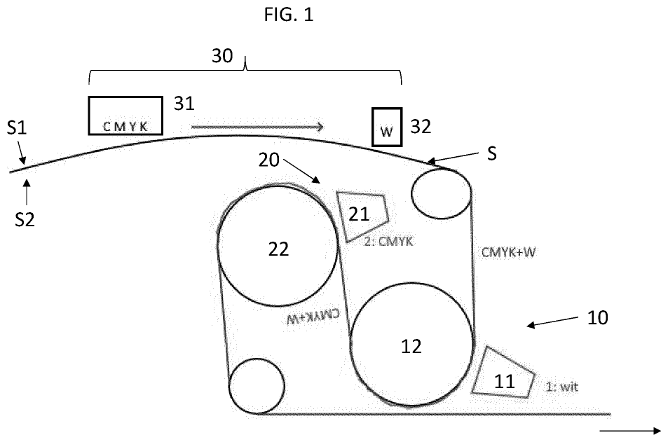

FIGS. 1-4 each illustrate a printing system for printing on a substrate S having a first side S1 and a second side S2. The printing system comprises an image application device 30, a first curing device 10 and a second curing device 20. The image application device 30 is configured for applying a radiation curable printing composition, preferably a light curable printing composition, typically a light curable ink, onto the first side of the substrate. The first curing device 10 is configured for emitting radiation, preferably light radiation, onto the first side S1 of the substrate S to cure at least a portion of the radiation curable printing composition. The first curing device 10 is located downstream of the image application device 30. The second curing device 20 is configured for emitting radiation, preferably light radiation, through the second side S2 of the substrate S to cure at least a portion of the radiation curable printing composition applied on the first side S1. The second curing device 20 is located downstream of the image application device 30.

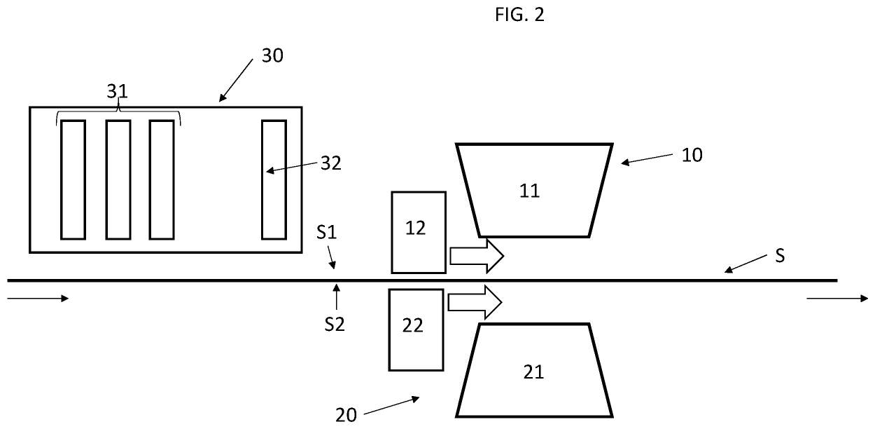

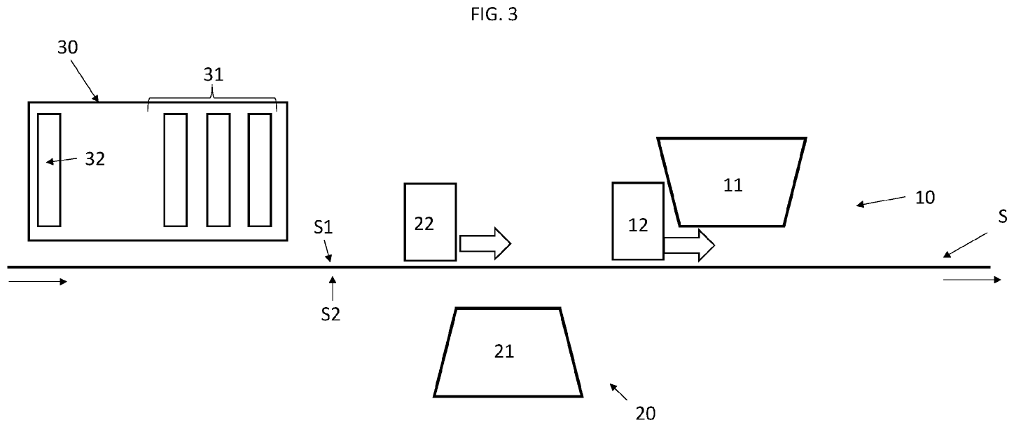

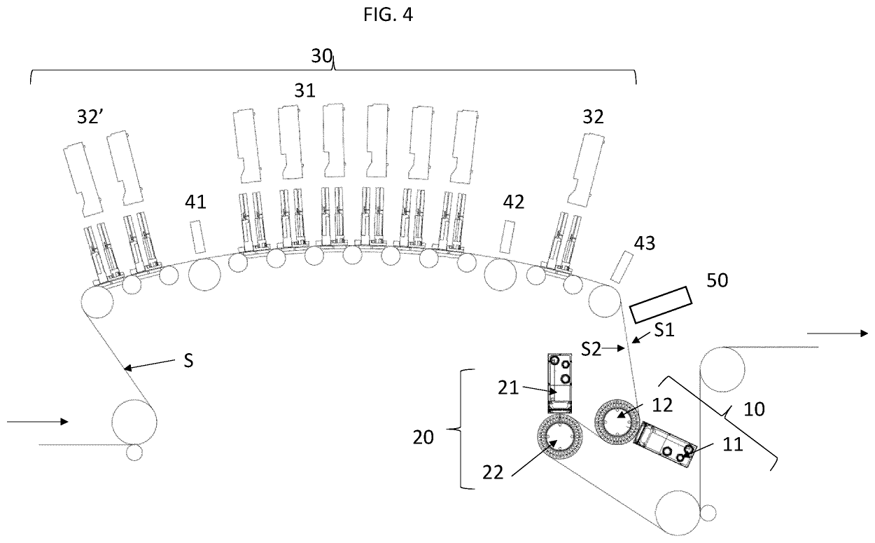

The image application device 30 comprises a color application section 31 configured for applying one or more colored curable printing compositions, such as CMYK color inks, and at least one additional layer application section 32, 32′ configured for applying an additional curable printing composition, such as a white ink or another dedicated color. In the embodiments of FIGS. 1 and 2 one additional layer application section 32 is included downstream of color application section 31, in the embodiment of FIG. 3 one additional layer application section 32′ is included upstream of color application section 31, and in the embodiment of FIG. 4 two additional layer application section 32, 32′ are included, one section 32′ upstream of color application section 31 and one section 32 downstream of color application section 31. However, it will be understood that a downstream section 32 and/or an upstream section 32′ may be included in any of the embodiments of FIGS. 1-4. When the color application section 31 is located upstream of an additional layer application section 32, the additional curable printing composition forms a top layer on a color layer applied by the color application section 31. For example, a highly reflective ink, such as white ink or silvery ink top layer may be applied on a color layer. When the color application section 31 is located downstream of an additional layer application section 32′, the additional curable printing composition forms a bottom layer between the first side S1 of the substrate S and the color layer. For example, a highly reflective ink, such as white ink or silvery ink bottom layer may be applied below a color layer. In some examples, it may be advantageous to have both a highly reflective ink, such as white ink or silvery ink bottom layer and a highly reflective ink, such as white ink or silvery ink top layer.

Preferably, the image application device 30 is an inkjet application device, e.g. a piezoelectric inkjet printer comprising piezo print heads or a thermal inkjet printer or an acoustic inkjet printer. Preferably, the inkjet printing by the printing application device 30 is performed in a single pass-mode. The image application device 30 may also be any other known device for printing inks, such as an offset printing press, a flexographic printing press, or a lithographic printing press.

In the embodiments of FIGS. 1-4, at least one of the first and second curing device 10, 20 is configured for cooling the substrate S during curing by the first and/or second curing device 10, 20, as will be further set out below.

In the embodiment of FIGS. 1 and 4, the second curing device 20 is located downstream of the first curing device 10. The first curing device 10 comprises a first heat transfer member 12, here a roller but this could also be a belt-like structure, configured for supporting and being in contact with the second side S2 of the substrate S during curing by the first curing device 10. The second curing device 20 comprises a second heat transfer member 22, here a roller but this could also be a belt-like structure, configured for supporting and being in contact with the first side S1 of the substrate S during curing by the second curing device 20. As can be seen in FIGS. 1 and 4, the printing system can be built in a compact manner, wherein curing and cooling can be performed simultaneously and wherein the heat transfer members 12, 22 also function as a support members of the substrate S. The first heat transfer member 12 is located upstream of the second heat transfer member 22, and the first heat transfer member 12 is arranged for being in contact with the second side S2 of the substrate whilst the second heat transfer member 22 is arranged for being in contact with the first already cured side S1 of the substrate. The first and second heat transfer members 12, 22 are first and second rollers and are arranged so that the substrate S is guided along a first side, here the lower side, of the first roller 12 and next around an opposite second side, here the upper side, of the second roller 22.

In the embodiment of FIG. 2 the first curing device 10 is located opposite the second curing means 20, and the substrate S passes between the first curing device 10 and the second curing device 20. Thus, a portion of the image applied on the substrate S will be simultaneously cured by the first curing device 10 and the second curing device 20.

In the embodiment of FIG. 3 the first curing device 10 is located downstream of the second curing device 20. Thus, a portion of an image applied on the substrate S will be first cured from the bottom by the second curing device 20 and next from the top by the first curing device 10.

In the embodiments of FIGS. 2 and 3 the first curing device 10 and second curing device 20 are each configured for cooling the substrate S with a gas flow, preferably an N₂ gas flow. However, in other embodiments only one of the curing devices 10, 20 may be configured for cooling the substrate S with a gas flow. In some embodiments it is preferred to apply the gas flow at the first side S1 of the substrate S in order to cool the applied curable printing composition, but in addition or alternatively it may also be advantageous to apply a gas flow at the second side S2, so that the substrate S is also cooled and thus also a portion of the applied curable printing composition near the substrate S. When for example a nitrogen gas flow is applied at the first side S1 during curing by the first curing device 10, oxygen inhibition may be caused which is typically advantageous for obtaining a good curing result.

In the embodiment of FIG. 4, the printing system further comprises a drying station 50 arranged downstream of the image application device 30 and upstream of the first and second curing device 10, 20. The drying station 50 may be configured to blow dry heated air along the substrate S, preferably under a relatively low pressure. Especially when water-based hybrid inks are used, it is advantageous to use a drying station 50 in order to ensure that the water is at least partially removed from the applied ink before starting the curing by the first and second curing device 10, 20. By at least partially drying the applied curable ink composition before curing, film formation of the curable liquid of the water-based hybrid ink is caused, so that subsequently a film of the curable liquid is cured by the first and second curing device 10, 20.

As illustrated in FIG. 4, optionally pinning devices 41, 42, 43 may be provided immediately after each application section 32′, 31, 32. Such pinning devices 41, 42, 43 may perform a brief curing of the radiation curable material that was applied immediately before. The dose applied by pinning devices 41, 42, 43 is typically at least five times lower than the dose needed to perform a full curing of the applied radiation curable printing composition, more preferably at least 10 times lower. In the embodiment of FIG. 4 only one drying station 50 is shown, but in other embodiments a drying station may be added after each application section 32′, 31, 32.

In preferred embodiments the first and second curing device 10, 20 are configured for emitting UV light radiation, and the substrate S is transparent or translucent to UV light. The first curing device 10 and the second curing device 10, 20 comprise a first UV light source 11 and a second UV light source 21, respectively. Preferably the first and second light sources 11, 21 comprise UV LEDs. However, it is also possible to use UV lamps or a combination of UV LEDs and UV lamps.

In preferred embodiments, the printing system further comprises a substrate transport means (not shown) configured to transport the substrate as a continuous web during printing along the image application device 30 and the first and second curing device 10, 20.

As illustrated in FIG. 1-4, the following steps are performed when printing on the substrate S:
using the image application device 30, applying, preferably by ink jetting, a radiation curable printing composition, preferably a light curable printing composition, typically light curable ink, onto the first side S1 of the substrate S;
using the first curing device 10, emitting radiation, preferably light radiation, onto the first side S1 of the substrate S, after the curable printing composition has been applied, to cure at least a portion of the radiation curable printing composition;
using the second curing device 20, emitting radiation, preferably light radiation, through the second side S2 of the substrate S, after the curable printing composition has been applied, to cure at least a portion of the radiation curable printing composition applied on the first side S1; wherein the substrate S is configured to allow the radiation to at least partially pass through the substrate S.

Preferably, the radiation curable printing composition is a UV curable ink. In some embodiments a water-based UV curable ink may be used.

The substrate S may be any known substrate suitable for ink printing and either translucent or transparent to at least part or all of the energy outputted by the second curing device 20. Thus, for example, while the substrate S does not need to be completely transparent or translucent, it should be of a type, thickness, porosity, opacity, or the like that allows at least a portion of the curing energy to penetrate through the substrate S to reach the applied curable composition.

Preferably, the substrate S is a flexible substrate made of a polymer material, such as a polyethylene or polypropylene material. The substrate S may be a packaging material and may be cut before or after the printing steps to form multiple packaging blanks. Preferably, the substrate S is configured such that it does not absorb the radiation curable composition. Preferably, the thickness of the substrate S is between 5 and 100 micron, more preferably between 5 and 50 micron, even more preferably between 5 and 30 micron.

The expression “radiation curable ink” means any colorless, colorized, white, or black ink composition that contains monomers that polymerize when the ink composition is exposed to a certain wavelength of the electro-magnetic spectrum. The radiation curable ink may be any ink that cures under radiation. For example, the radiation curable ink may be an ultra-violet (UV) curable ink. Ink compositions according to this disclosure generally include a carrier, a colorant, and one or more additional additives. Such additives can include, for example, solvents, waxes, antioxidants, tackifiers, slip aids, curable components such as curable monomers and/or polymers, gellants, initiators, sensitizers, humectants, biocides, preservatives, and the like. Generally, the ink compositions contain one or more colorant. Any desired or effective colorant can be employed in the ink compositions, including pigment, dye, mixtures of pigment and dye, mixtures of pigments, mixtures of dyes, and the like.

The expression “UV light” means ultra-violet electromagnetic radiation in the spectrum of wavelengths between about 1 and about 400 nanometers.

The term “curable” refers, for example, to the composition being polymerizable, that is, a material that may be cured via polymerization, including for example free radical routes, and/or in which polymerization is photoinitiated though use of a radiation sensitive photo-initiator. Thus, for example, the term “radiation curable” is intended to cover all forms of curing upon exposure to a radiation source, including light and heat sources and including in the presence or absence of initiators. Example radiation curing routes include, but are not limited to, curing using ultraviolet (UV) light, for example having a wavelength of 200-400 nm or more rarely, visible light, such as in the presence of photo-initiators and/or sensitizers, curing using e-beam radiation, such as in the absence of photo-initiators, curing using thermal curing, in the presence or absence of high temperature thermal initiators (and which are generally largely inactive at the jetting temperature), and appropriate combinations thereof. The curing process is a polymerization that can proceed by a radical or cationic pathway or a combination of both.

Whilst the principles of the invention have been set out above in connection with specific embodiments, it is to be understood that this description is merely made by way of example and not as a limitation of the scope of protection which is determined by the appended claims.

1. A printing system for printing on a substrate(S) having a first side and a second side, comprising:
an image application device configured for applying a radiation curable printing composition, preferably a light curable printing composition, typically a light curable ink, onto the first side of the substrate;
a first curing device configured for emitting radiation, preferably light radiation, onto the first side of the substrate to cure at least a portion of the radiation curable printing composition, said first curing device being located downstream of the image application device;
a second curing device configured for emitting radiation, preferably light radiation, through the second side of the substrate to cure at least a portion of the radiation curable printing composition applied on the first side, said second curing device being located downstream of the image application device;
wherein the image application device comprises:
a color application section configured for applying one or more colored curable printing compositions, such as CMYK color inks, and
at least one additional layer application section configured for applying an additional curable printing composition, such as a white ink;
wherein the color application section is located upstream and/or downstream of an additional layer application section of the at least one additional layer application section, such that the additional curable printing composition forms a top layer on a color layer applied by the color application section and/or a bottom layer between the first side of the substrate and the color layer, respectively.

2. The printing system of claim 1, wherein the system is configured such that the applied curable printing composition is not cured or only partially cured between the application of two colored printing compositions of said one or more colored curable printing compositions or between the application of a colored printing composition of said one or more colored curable printing compositions and an additional curable printing composition.

3. The printing system of claim 1, wherein the second curing device is located downstream of the first curing device.

4. The printing system of claim 1, wherein at least one of the first and second curing device is configured for cooling the substrate during curing by the first and/or second curing device, wherein optionally the first curing device comprises a heat transfer member configured for supporting and being in contact with the second side of the substrate during curing by the first curing device.

5. (canceled)

6. The printing system of claim 4, wherein the second curing device comprises a heat transfer member, such as a roller, configured for supporting and being in contact with the first side of the substrate during curing by the second curing device.

7. The printing system of claim 1, wherein the first curing device is located downstream of the second curing device or opposite the second curing means.

8. The printing system of claim 1, wherein at least one of the first and second curing device is configured for cooling the applied curable ink composition with a gas flow.

9. The printing system of claim 1, wherein the first and second curing device are configured for emitting UV light radiation, wherein optionally the first and second curing device comprise UV LEDs.

10. The printing system of claim 1, further comprising a drying station downstream of the image application device and upstream of the first and second curing device.

11. (canceled)

12. The printing system of claim 1, wherein the image application device is an inkjet application device.

13. The printing system of claim 1, further comprising a substrate transport means configured to transport the substrate as a continuous web during printing along the image application device and the first and second curing device.

14. A method for printing on a substrate having a first side and a second side, comprising:
applying a radiation curable printing composition, preferably a light curable printing composition, typically light curable ink, onto the first side of the substrate;
emitting radiation, preferably light radiation onto the first side of the substrate, after the curable printing composition has been applied, to cure at least a portion of the radiation curable printing composition;
emitting radiation, preferably light radiation through the second side of the substrate, after the curable printing composition has been applied, to cure at least a portion of the radiation curable printing composition applied on the first side; wherein the substrate is configured to allow at least a portion of the radiation to pass through the substrate;
wherein the applying comprises:
applying one or more colored curable printing compositions, such as CMYK color inks, to form a color layer; and
applying an additional curable printing composition, such as a white ink, as a top layer on the color layer and/or as a bottom layer between the first side of the substrate and the color layer.

15. The method of claim 14, wherein the substrate is substantially transparent to UV light and/or wherein the radiation is UV light radiation.

16. The method of claim 14, wherein the emitting of radiation through the second side is performed after the emitting of radiation onto the first side, wherein optionally the emitting of radiation through the second side is performed before or at the same time as the emitting of radiation onto the first side.

17. (canceled)

18. The method of claim 14, further comprising cooling the substrate during the emitting of radiation onto the first side and/or onto the second side, wherein optionally the cooling is done using a heat transfer member and/or using a gas flow, preferably an N2 gas flow, and wherein optionally the cooling is done by applying a gas flow at the first side and/or at the second side of the substrate.

19-20. (canceled)

21. The method of claim 14, wherein the radiation curable printing composition is a water-based ink and/or wherein the applying is done by ink jetting and/or wherein the substrate is made of a polymer material, such as a polyethylene or polypropylene material.

22. (canceled)

23. The method of claim 14, wherein the substrate is configured such that it does not absorb the radiation curable composition.

24-25. (canceled)

26. The method of claim 14, wherein the substrate is transported as a continuous web during the applying and the emitting steps.

27. A substrate with a printed image obtained using the method of claim 14.

28. A method for packaging a product, comprising wrapping the substrate of claim 27 around the product, wherein preferably the printed first side of the substrate is facing the product.
